(19) United States
(12) Patent Application Publication
(10) Pub. No.: US 2013/0055371 A1
(43) Pub. Date: Feb. 28, 2013

(54) STORAGE CONTROL METHOD AND INFORMATION PROCESSING APPARATUS

(71) Applicants: Tatsuo Kumano, Kawasaki (JP); Yasuo Noguchi, Kawasaki (JP); Munenori Maeda, Yokohama (JP); Masahisa Tamura, Kawasaki (JP); Ken Iizawa, Yokohama (JP); Toshihiro Ozawa, Yokohama (JP); Takashi Watanabe, Kawasaki (JP)

(72) Inventors: Tatsuo Kumano, Kawasaki (JP); Yasuo Noguchi, Kawasaki (JP); Munenori Maeda, Yokohama (JP); Masahisa Tamura, Kawasaki (JP); Ken Iizawa, Yokohama (JP); Toshihiro Ozawa, Yokohama (JP); Takashi Watanabe, Kawasaki (JP)

(73) Assignee: FUJITSU LIMITED, Kawasaki-shi (JP)

(21) Appl. No.: 13/584,449

(22) Filed: Aug. 13, 2012

(30) Foreign Application Priority Data
Aug. 26, 2011 (JP) 2011-184309

(51) Int. Cl. G06F 21/20

(52) U.S. Cl. 726/7

(57) ABSTRACT

Upon receipt of a first key and first data, a control unit exercises control to store second data indicating a second key in association with the first key in a first node and to store the first data in association with the second key in a second node. Upon receipt of an access request that specifies the first key, the control unit detects that data stored in association with the first key is the second data, and accesses the first data stored in the second node on the basis of the second key indicated by the second data.

### CROSS-REFERENCE TO RELATED APPLICATION

This application is based upon and claims the benefit of priority of the prior Japanese Patent Application No. 2011-184309, filed on Aug. 26, 2011, the entire contents of which are incorporated herein by reference.

### FIELD

The embodiments discussed herein relate to a storage control method and an information processing apparatus.

### BACKGROUND

Currently, distributed storage systems are deployed. In a distributed storage system, a plurality of storage nodes is connected over a network. Data is stored in a distributed manner over the plurality of storage nodes, thereby speeding up data access. Some distributed storage systems use Key-Value Store (KVS). The KVS provides functions of assigning a key to data (value) and storing them as a key-data pair in any of storage nodes. To access the stored data, a corresponding key is specified. Data is stored in a distributed manner over the storage nodes according to assigned keys.

In this connection, another method may be employed for storing and retrieving data. For example, a B-tree is suitable for data search. In the B-tree, a node holds a pointer to its child node. A node may be so designed as to hold a pointer to a subnode included in a subtree. In addition, for example, there is also a method in which a value is stored in a memory region, and the value is retrieved from the region by giving a pointer indicating the region to a predetermined function. Please see, for example, Japanese Laid-open Patent Publication No. 7-191891 and International Publication Pamphlet No. WO 00/07101.

In the case where a correspondence between keys and storage nodes is registered in a distributed storage system in which a storage node to be accessed is identified based on a key, an imbalance in the amount of data or the number of received accesses may occur among the storage nodes, and it is difficult to reduce the imbalance as long as a node to be used for storing data is selected according to the registered correspondence.

### SUMMARY

According to an aspect, there is provided a storage control method to be executed in a system where a plurality of nodes is provided for storing data in association with a key and a node to be accessed is identified based on the key. The storage control method includes: storing, upon reception of a first key and first data, second data indicating a second key in association with the first key in a first node identified by the first key, and storing the first data in association with the second key in a second node; and detecting, upon reception of an access request that specifies the first key, data stored in association with the first key in the first node is the second data, and accessing the first data stored in the second node on the basis of the second key indicated by the second data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing system according to a first embodiment;

FIG. 2 illustrates a distributed storage system according to a second embodiment;

FIG. 3 illustrates example hardware components of a storage node according to the second embodiment;

FIG. 4 is a block diagram illustrating example software components according to the second embodiment;

FIG. 5 illustrates example assignment of ranges of hash values according to the second embodiment.

FIG. 6 illustrates an example assignment management table according to the second embodiment;

FIG. 7 illustrates an example pointer management table according to the second embodiment;

FIG. 8 illustrates a first example of a data store according to the second embodiment;

FIG. 9 illustrates a second example of a data store according to the second embodiment;

FIG. 10 is a flowchart illustrating a write process according to the second embodiment;

FIG. 11 is a flowchart illustrating a process for determining a data destination node according to the second embodiment;

FIG. 12 is a flowchart illustrating a process for determining a pointer key according to the second embodiment;

FIG. 13 is a flowchart illustrating a read process according to the second embodiment;

FIG. 14 is a flowchart illustrating a deletion process according to the second embodiment;

FIG. 15 is a block diagram illustrating example software components according to a third embodiment;

FIG. 16 is a flowchart illustrating a write process according to the third embodiment;

FIG. 17 is a flowchart illustrating a read process according to the third embodiment; and

FIG. 18 is a flowchart illustrating a deletion process according to the third embodiment.

### DESCRIPTION OF EMBODIMENTS

Several embodiments will be described below with reference to the accompanying drawings, wherein like reference numerals refer to like elements throughout.

### First Embodiment

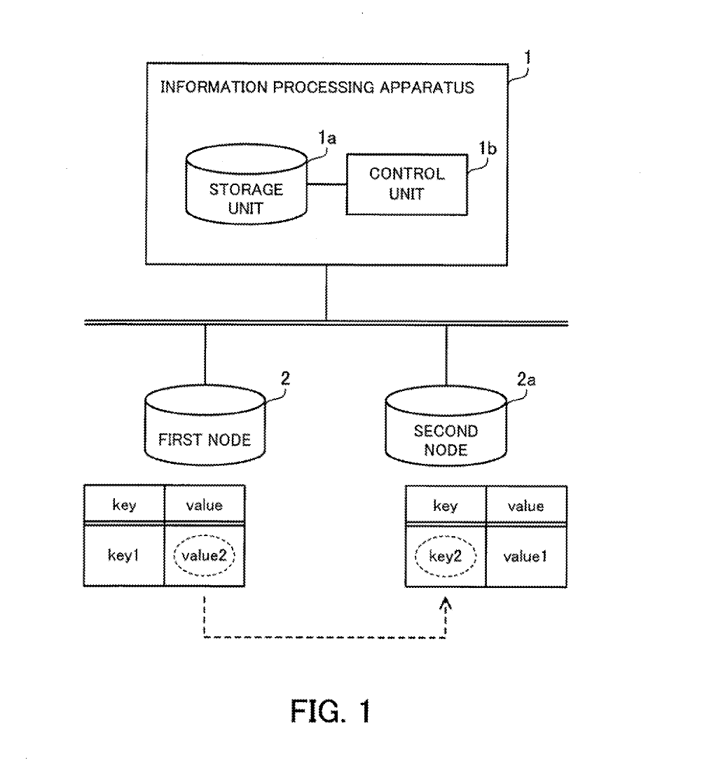

FIG. 1 illustrates an information processing system according to a first embodiment. The information processing system according to the first embodiment is a system in which a plurality of nodes is provided for storing data (values) in association with keys, and a node to be accessed is identified based on a key. This information processing system includes an information processing apparatus 1 and first and second nodes 2 and 2a. Each node is an information processing apparatus that is provided with an internal or external storage device to store data. The information processing apparatus 1 and the first and second nodes 2 and 2a are connected over a network.

The information processing apparatus 1 may include a processor such as a Central Processing Unit (CPU) and a memory such as a Random Access Memory (RAM), or may be a computer that executes programs stored in a memory with a processor. The information processing apparatus 1 includes a storage unit 1a and control unit 1b.

The storage unit 1a stores information indicating a correspondence between keys and nodes. This information indicates that the first node 2 corresponds to a first key (key1) and the second node 2a corresponds to a second key (key2). The storage unit 1a is implemented by using a RAM or Hard Disk Drive (HDD).

When receiving the first key (key1) and first data (value1), the control unit 1b exercises control to store second data (value2) indicating the second key (key2) in association with the first key (key1) in the first node 2, and to store the first data (value1) in association with the second key (key2) in the second node 2a. In this connection, it is optional whether the second key (key2) is used as the second data (value2) or not. For example, data generated by eliminating a predetermined prefix from the second key (key2) may be used as the second data (value2).

Then, when receiving an access request that specifies the first key (key1), the control unit 1b detects that data stored in association with the first key (key1) is the second data (value2). Then, the control unit 1b accesses the first data (value1) stored in the second node 2a on the basis of the second key (key2) indicated by the second data (value2).

For example, the control unit 1b recognizes the second data with one of the following methods. A first method is that, when storing the second data, the control unit 1b also registers predetermined control data (for example, flag) denoting the second data, in association with the first key in the first node 2. This method enables the control unit 1b to detect that the data associated with the first key is the second key, on the basis of the control data associated with the first key. A second method is that a predetermined rule (for example, a predetermined character string is included) for recognizing the second data is previously defined. This method enables the control unit 1b to recognize the second data based on whether data associated with the first key satisfies the rule.

In the information processing apparatus 1, when receiving the first key and first data, the control unit 1b exercises control to store second data indicating the second key in association with the first key in the first node 2 and to store the first data in association with the second key in the second node 2a. Then, when receiving an access request that specifies the first key, the control unit 1b detects that the data stored in association with the first key is the second data, and accesses the first data stored in the second node on the basis of the second key indicated by the second data.

This technique enables more flexible data placement in a plurality of nodes. More specifically, even in the case where a storage destination of data is determined based on the first key with the KVS, which provides a function of determining a storage destination based on a key, the second key may be stored in the storage destination, instead of the data, and the actual data may be stored in a different device. For example, in the case where the storage destination determined based on the first key has a small free space, an imbalance in the amount of data is reduced by storing the actual data in another node. The second key is information that simply indicates a link to data, and probably has a smaller data size than the actual data. On the other hand, in the case where a large load is imposed on the storage destination determined based on the first key, load is distributed by, for example, storing the actual data in another node.

In this connection, the functions of the control unit 1b may be provided in the first and second nodes 2 and 2a. In this case, for example, at the time of writing the first data (value1), the first node 2 stores a key-value pair (key1, value2) therein. Then, the first node 2 causes the second node 2a to store a key-value pair (key2, value1). When receiving an access request that specifies the first key (key1), the first node 2 recognizes the second data (value2) associated with the first key (key1). Then, the first node 2 accesses the first data (value1) stored in the second node 2a by specifying the second key (key2) indicated by the second data (value2).

### Second Embodiment

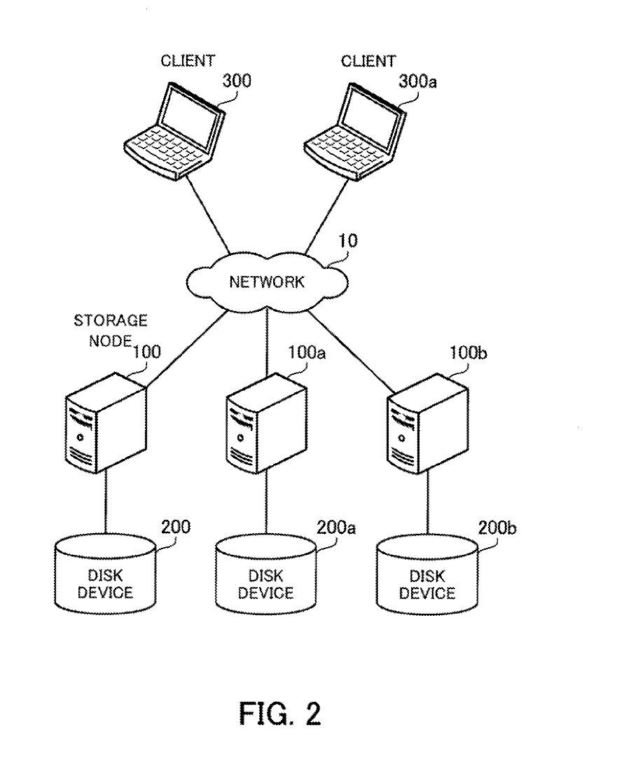

FIG. 2 illustrates a distributed storage system according to a second embodiment. The distributed storage system according to the second embodiment stores data in a distributed manner over a plurality of storage nodes by using the KVS. The distributed storage system according to the second embodiment includes storage nodes 100, 100a, and 100b, disk devices 200, 200a, and 200b, and clients 300 and 300a.

The storage nodes 100, 100a, and 100b and clients 300 and 300a are connected to a network 10. The network 10 may be a Local Area Network (LAN) or a wide-area network such as the Internet.

The disk devices 200, 200a, and 200b are connected to the storage nodes 100, 100a, and 100b, respectively. For example, a Small Computer System Interface (SCSI) or a Fibre Channel may be used as an interface between the storage nodes 100, 100a, 100b and the corresponding disk devices 200, 200a, and 200b. The storage nodes 100, 100a, and 100b are server computers that perform data write (Write), data read (Read), and data deletion (Deletion) on the corresponding disk devices 200, 200a, and 200b.

The disk devices 200, 200a, and 200b are storage drives for storing data. The disk devices 200, 200a, and 200b are provided with an HDD, Solid State Drive (SSD), or other storage devices. The disk devices 200, 200a, and 200b may be built into the storage nodes 100, 100a, and 100b, respectively.

The clients 300 and 300a are client computers that access data stored in the distributed storage system. For example, the clients 300 and 300a are terminal devices that are operated by users. The clients 300 and 300a issue data access requests to the storage nodes 100, 100a, and 100b. The access requests include data write requests (write request), data read requests (read request), and data deletion requests (deletion request).

The disk devices 200, 200a, and 200b store key and data (value) as a pair (key, value). When receiving a data write request that specifies a key, the storage node 100, 100a, and 100b writes the data associated with the key. When receiving a data read request that specifies a key, the storage node 100, 100a, and 100b reads the data associated with the key the key. When receiving a data deletion request that specifies a key, the storage node 100, 100a, and 100b deletes the data associated with the key together with the key.

The storage node 100, 100a, and 100b determines which storage node holds data, on the basis of a hash value calculated from a key. The hash value corresponding to the key is calculated with, for example, the Message Digest algorithm 5 (MD5). The Secure Hash Algorithm (SHA) or another hash function may also be used. A method for determining a storage node responsible (hereinafter, also called an assigned node) on the basis of the hash value corresponding to the key may be called consistent hashing.

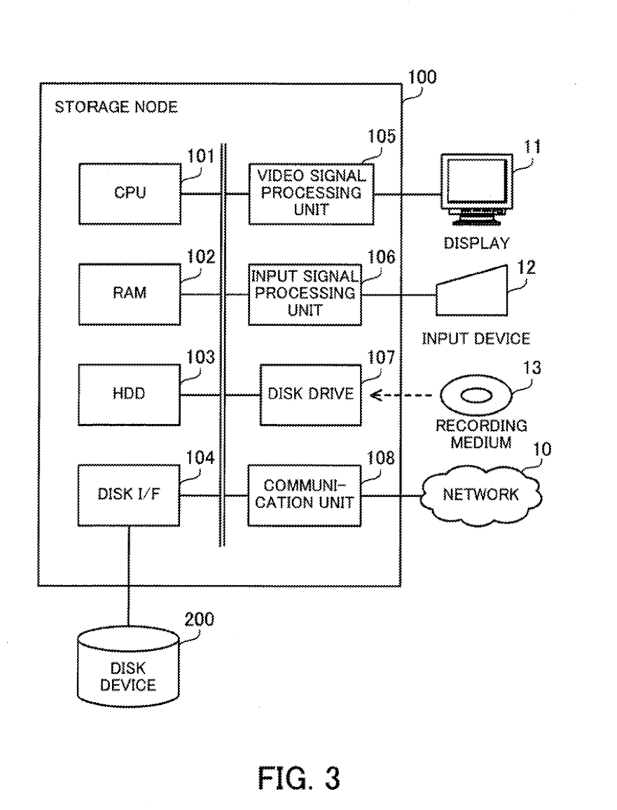

FIG. 3 illustrates example hardware components of a storage node according to the second embodiment. The storage node 100 includes a CPU 101, RAM 102, HDD 103, disk interface (I/F) 104, video signal processing unit 105, input signal processing unit 106, disk drive 107, and communication unit 108. These components are connected to a bus in the storage node 100. The storage nodes 100a and 100b and clients 300 and 300a may have the same hardware components as the storage node 100.

The CPU 101 is a processor that controls information processing performed by the storage node 100. The CPU 101 reads at least part of programs and data from the HDD 103, and runs the programs by deploying the programs in the RAM 102. In this connection, the storage node 100 may be provided with a plurality of processors to execute a program in parallel.

The RAM 102 is a volatile memory that temporarily stores programs to be executed by the CPU 101 and data to be used in processing. In this connection, the storage node 100 may be provided with a variety of memories other than RAM or a plurality of memories.

The HDD 103 is a non-volatile storage device that stores programs such as operating system (OS) programs and application programs, and data. The HDD 103 performs data read and write on an internal magnetic disk under the control of the CPU 101. In this connection, the storage node 100 may be provided with a variety of non-volatile storage devices (for example, SDD) other than HDD or a plurality of storage devices.

The disk interface 104 is an interface for connecting to the disk device 200, and is implemented by using SCSI or Fibre Channel.

The video signal processing unit 105 outputs images to a display 11 connected to the storage node 100 under the control of the CPU 101. The display 11 may be a Cathode Ray Tube (CRT) display or liquid crystal display.

The input signal processing unit 106 receives and transfers input signals from an input device 12 connected to the storage node 100 to the CPU 101. The input device 12 may be a pointing device such as a mouse or touch panel, or a keyboard.

The disk drive 107 is a drive device that reads programs and data from a recording medium 13. The recording medium 13 may be a magnetic disk such as flexible disk FD or HDD, an optical disc such as Compact Disc (CD) or Digital Versatile Disc (DVD), or a magneto-Optical disk (MO). The disk drive 107 stores the programs and data read from the recording medium 13 in the RAM 102 or HDD 103 under the control of the CPU 101, for example.

The communication unit 108 is a communication interface for communicating with the storage nodes 100a and 100b and clients 300 and 300a over the network 10. The communication unit 108 may be a wired or wireless communication interface.

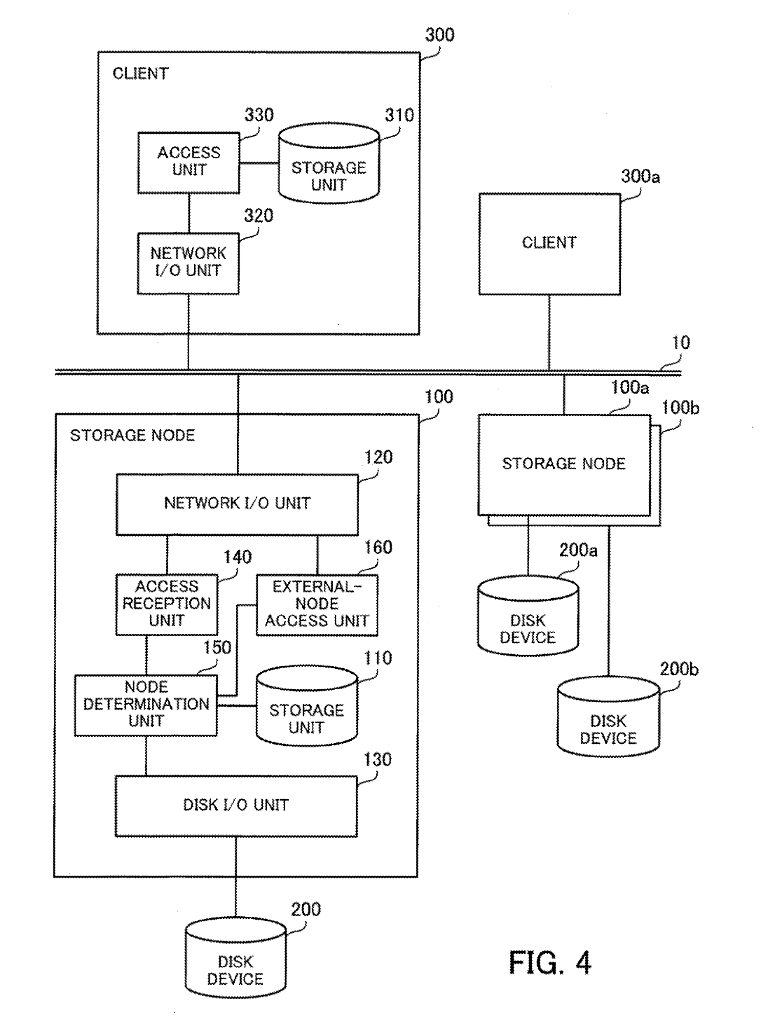

FIG. 4 is a block diagram illustrating example software components according to the second embodiment. Some or all of the components illustrated in FIG. 4 may be program modules to be executed by the storage nodes 100, 100a, and 100b and clients 300 and 300a, or may be implemented by using a Field Programmable Gate Array (FPGA), Application Specific Integrated Circuit (ASIC), or other electronic circuits. The storage nodes 100a and 100b may be implemented by using the same components as the storage node 100. In addition, the client 300a may also be implemented by using the same components as the client 300.

The storage node 100 includes a storage unit 110, network input/output (I/O) unit 120, disk I/O unit 130, access reception unit 140, node determination unit 150, and external-node access unit 160.

The storage unit 110 stores an assignment management table and pointer management table. The assignment management table contains information for managing assigned nodes responsible for hash values. The pointer management table contains information for managing pointer keys and storage nodes (hereinafter, may be referred to as data destination node) in which data associated with the pointer keys have been placed. A pointer key is information that indicates a link to a data destination node.

The network I/O unit 120 receives an access request from the client 300 and 300a, and outputs the access request to the access reception unit 140. The network I/O unit 120 also transmits an access request received from the external-node access unit 160 to the requested storage node 100a and 100b, thereby accessing the storage node 100a and 100b. The external-node access unit 160 outputs data received from the storage node 100a and 100b to the network I/O unit 120. The network I/O unit 120 transmits data received from the access reception unit 140 and external-node access unit 160 to the clients 300 and 300a.

The disk I/O unit 130 writes a pair of key and data received from the node determination unit 150 to the disk device 200. The disk I/O unit 130 also reads data associated with a key specified by the node determination unit 150, from the disk device 200, and outputs the data to the node determination unit 150.

The access reception unit 140 outputs an access request received from the network I/O unit 120 to the node determination unit 150. The access reception unit 140 also returns data received from the node determination unit 150 to the access-requesting client 300 and 300a via the network I/O unit 120.

The node determination unit 150 determines an assigned node to be accessed, with reference to the assignment management table stored in the storage unit 110. The node determination unit 150 instructs the disk I/O unit 130 to perform data access (write, read, deletion) according to the key if its own node (storage node 100) is an assigned node. The node determination unit 150 outputs an access result (write completion or read data) received from the disk I/O unit 130 to the access reception unit 140. If the other node (storage node 100a or 100b) is an assigned node, on the other hand, the node determination unit 150 instructs the external-node access unit 160 to make an access request to another node.

In the case where the own node is an assigned node for processing a write request, the node determination unit 150 determines a data destination node for storing actual data depending on the utilization of the own node. If another node is determined to be a data destination node, the node determination unit 150 generates a pointer key linking to the data destination node, and stores the pointer key in association with the specified key in the disk device 200. Then, the node determination unit 150 requests the data destination node to store the actual data associated with the pointer key. If the own node is a data destination node, the node determination unit 150 stores the data in association with the specified key in the disk device 200.

In addition, in the case where the own node is an assigned node for processing a read request and the read data is a pointer key, the node determination unit 150 determines a data destination node with reference to the pointer management table stored in the storage unit 110. The node determination unit 150 then instructs the external-node access unit 160 to acquire data associated with the pointer key from the data destination node and to return the data to the requesting client 300 and 300a. If the read data is not a pointer key, on the other hand, the node determination unit 150 returns the data to the requesting client 300 and 300a.

In addition, in the case where the own node is an assigned node for processing a deletion request and the data associated with a specified key is a pointer key, the node determination unit 150 determines a data destination node with reference to the pointer management table stored in the storage unit 110. The node determination unit 150 then instructs the external-node access unit 160 to request the data destination unit to delete the data associated with the pointer key. If the read data is not a pointer key, on the other hand, the node determination unit 150 deletes the data associated with the specified key from the disk device 200.

The external-node access unit 160 generates an access request for accessing another node in accordance with an instruction from the node determination unit 150, and then transmits the access request to the other node via the network I/O unit 120. Then, the external-node access unit 160 returns data received from the other node to the access-requesting client 300 and 300a via the network I/O unit 120.

The client 300 includes a storage unit 310, network I/O unit 320, and access unit 330.

The storage unit 310 stores data to be used by the client 300.

The network I/O unit 320 transmits an access request received from the access unit 330 to any of the storage nodes 100, 100a, and 100b (for example, storage node 100). The network I/O unit 320 receives a response to the access request from the storage node 100, 100a, and 100b, and outputs the response to the access unit 330.

The access unit 330 generates an access request according to a data access made by a predetermined application, and outputs the access request to the network I/O unit 320. As described earlier, access requests include write requests, read requests, and deletion requests. The access unit 330 includes a key for target data in the access request. A key is specified by the application, for example. The application, which causes the access unit 330 to generate a data access, is not illustrated in FIG. 4. The application may be implemented by a program to be executed by the client 300, or may be implemented on another information processing apparatus, for example.

In this connection, the storage node 100 according to the second embodiment is just an example of the information processing apparatus 1 of the first embodiment. The node determination unit 150 and external-node access unit 160 are just examples of the control unit 1b of the information processing apparatus 1.

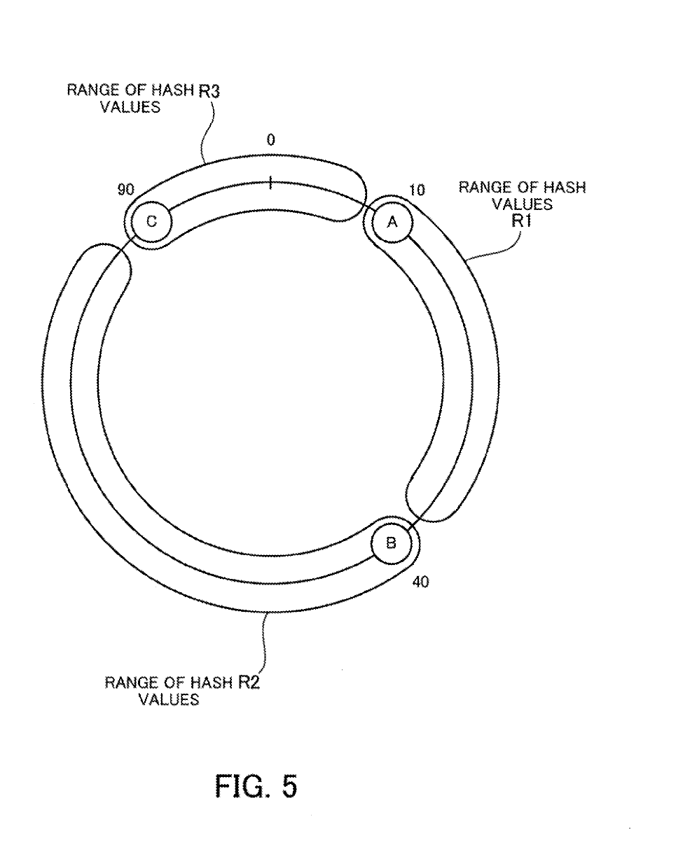

FIG. 5 illustrates example assignment of ranges of hash values according to the second embodiment. In the distributed storage system according to the second embodiment, available hash values range from 0 to 99. In this connection, a value of “0” follows “99”. Three ranges obtained by dividing the full range are assigned to the respective storage nodes 100, 100a, and 100b. In FIG. 5, labels “A”, “B”, “C” and are the identification information of the storage nodes 100, 100a, and 100b, respectively. The position of each label indicates the start point of a range which the storage node with the label is responsible for.

Referring to FIG. 5, the ranges of hash values R1, R2, and R3 are illustrated, each of which includes a value corresponding the position of a label. A range of hash values R1 is “10 to 39”, and the storage node 100 is responsible for this range R1. A range of hash values R2 is “40 to 89”, and the storage node 100a is responsible for this range R2. A range of hash values R3 is “90 to 99” and “0 to 9”, and the storage node 100b is responsible for this range R3. The hash value range R3 includes the values of “99” and “0”.

In the distributed storage system according to the second embodiment, a range of hash values is assigned to a storage node 100, 100a, and 100b by specifying the value of one end of the range. For example, consider the case of specifying the smaller one (start position) of the values of both ends of a range. In this case, hash values “10” and “40” are specified for the storage nodes 100 and 100a, respectively. Thereby, the storage node 100 becomes responsible for a range of “10 to 39”. As for a range including a value of “0”, as in the case of the range of hash values R3, the larger one of the values of both ends of the range is taken as a start position, which is an exceptional. In this case, for example, the range including the value of “0” is assigned by specifying a hash value of “90”.

Alternatively, consider the case of specifying the larger one (end position) of the values of both ends of a range to assign the range. In this case, for example, hash values “39”, “89”, and “9” are specified for the storage nodes 100, 100a, and 100b, respectively, so that the storage nodes 100, 100a, and 100b become responsible for the respective ranges that are identical to the ranges of hash values R1, R2, and R3 illustrated in FIG. 5. With respect to the range including a value of “0”, the smaller one of the values of both ends thereof is taken as an end position, which is an exceptional. That is, the range including the value of “0” is assigned by specifying the smaller one of the values of both ends thereof.

The following describes the case where ranges are assigned to the storage nodes 100, 100a, and 100b by specifying the start positions of the ranges.

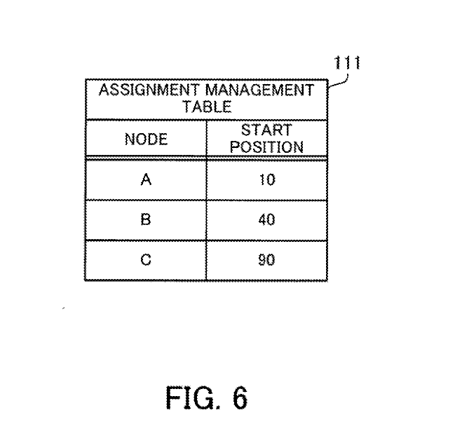

FIG. 6 illustrates an example assignment management table according to the second embodiment. The assignment management table 111 is stored in the storage unit 110. The assignment management table 111 has fields for node and start position.

The node field contains the label of a storage node. The start position field contains a value corresponding to the start position of a range which the storage node is responsible for. The assignment management table 111 indicates the assignment of FIG. 5.

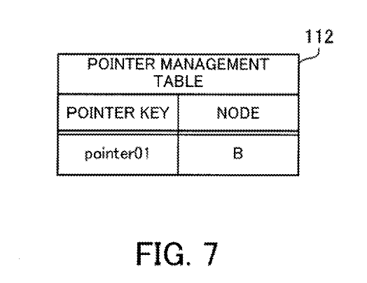

FIG. 7 is an example pointer management table according to the second embodiment. The pointer management table 112 is stored in the storage unit 110. The pointer management table 112 has fields for pointer key and node.

The pointer key field contains a pointer key. The node field contains the label of a storage node. For example, a record with a pointer key “pointer01” and a node “B” means that the pointer01 is a link to the storage node 100b.

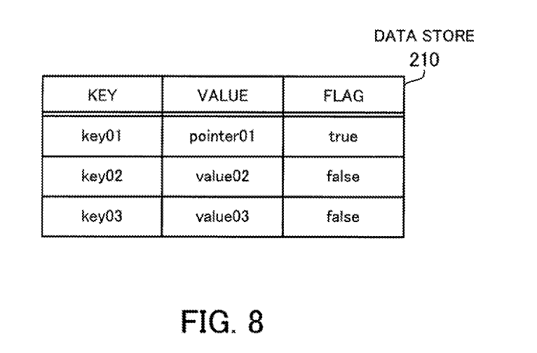

FIG. 8 illustrates a first example of a data store according to the second embodiment. In a data store 210, data (value) is stored in association with a key in the disk device 200. In addition, a flag indicating whether the data (value) is a pointer key or not is stored in association with the key. A flag of “true” indicates that data is a pointer key. A flag of “false” indicates that data is not a pointer key.

For example, a key “key01” is associated with a flag of “true”. Therefore, the data “pointer01” associated with the key “key01” is a pointer key. As another example, a key “key02” is associated with a flag of “false”. Therefore, the data “value02” associated with the key “key02” is not a pointer key. The node determination unit 150 registers a flag in association with a key when performing data write.

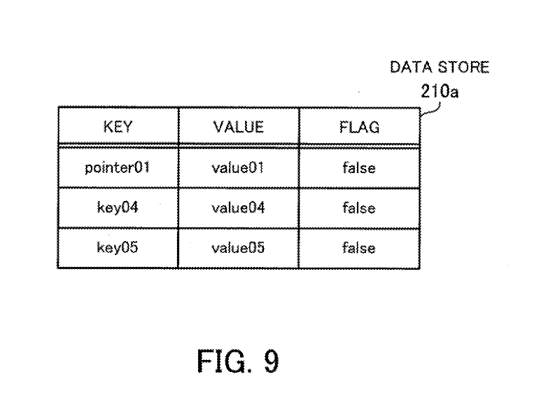

FIG. 9 illustrates a second example of a data store according to the second embodiment. The data store 210a is stored in the disk device 200a. The data store 210a has the same data structure as the data store 210. For example, the data store 210a has a record with a key “pointer01” and a flag “false”. Therefore, the data “value01” associated with the key “pointer01” is not a pointer key.

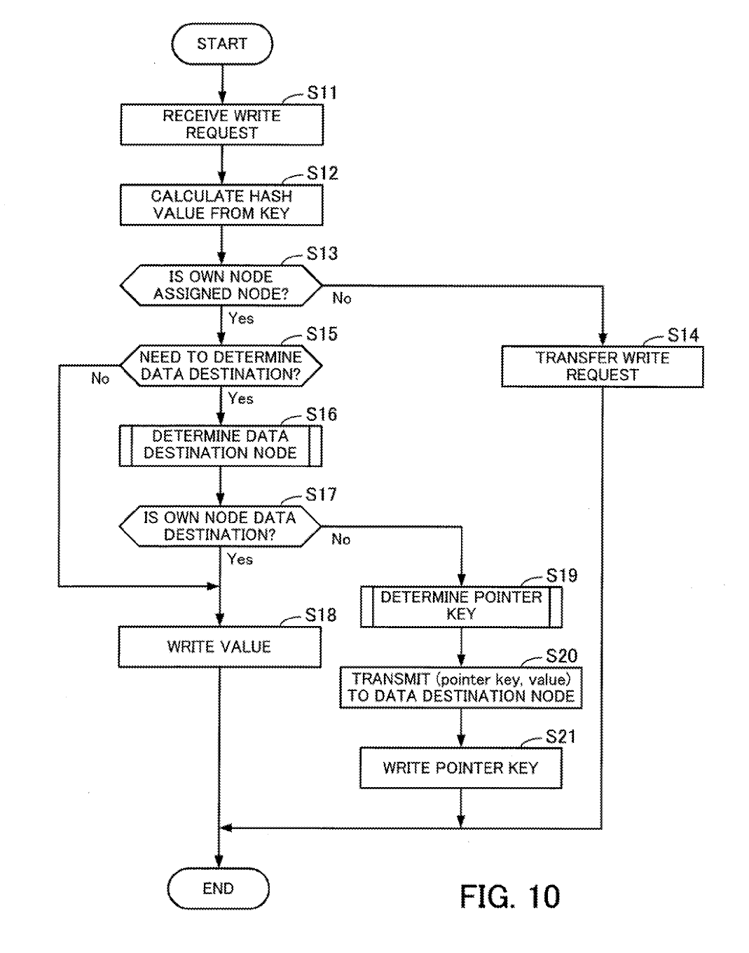

FIG. 10 is a flowchart illustrating a write process according to the second embodiment. This process will be described according to the flowchart.

At step S11, the network I/O unit 120 receives a write request from the client 300. The network I/O unit 120 outputs the write request to the node determination unit 150 via the access reception unit 140. For example, the write request includes a key “key01” and data “value01”.

At step S12, the node determination unit 150 calculates a hash value from the key included in the write request.

At step S13, the node determination unit 150 determines with reference to the assignment management table 111 stored in the storage unit 110 whether its own node is an assigned node responsible for the calculated hash value or not. If the own node is not the assigned node, the process goes on to step S14. If the own node is the assigned node, the process goes on to step S15.

At step S14, the node determination unit 150 transfers the write request to the assigned node via the network I/O unit 120. The assigned node, having the write request, writes the data to the disk device connected thereto, and returns a result to the client 300. Then, the process is completed.

At step S15, the node determination unit 150 determines whether to determine a data destination node for placing actual data. If the data destination node needs to be determined, the process goes on to step S16. Otherwise, the process goes on to step S18. The node determination unit 150 determines based on one or both of the following criteria (1) and (2) whether to determine a data destination node. (1) The disk device 200 has a free space less than a predetermined value. (2) The size of data to be placed is larger than a predetermined value. In the case of using both criteria, determination of a data destination node may be performed when either one or both of the criteria are satisfied. Alternatively, other criteria may be used.

At step S16, the node determination unit 150 determines a data destination node. A process for this determination will be described in detail later.

At step S17, the node determination unit 150 determines whether the determined data destination node is its own node or not. If the data destination node is the own node, the process goes on to step S18. Otherwise, the process goes on to step S19.

At step S18, the node determination unit 150 instructs the disk I/O unit 130 to write the data (value) to the disk device 200, and at the same time, to write the key and flag for the data as well. The key is a key specified by the write request. The flag is “false”. The disk I/O unit 130 writes a set of (key, value, flag) to the disk device 200, and notifies the node determination unit 150 of the result. Then, the node determination unit 150 returns the write result to the client 300 via the network I/O unit 120. For example, a set (“key01”, “value01”, “false”) is written to the data store 210. Then, the process is completed.

At step S19, the node determination unit 150 determines a pointer key. This process will be described in detail later. For example, a pointer key “ponter01” is determined.

At step S20, the node determination unit 150 instructs the external-node access unit 160 to request the data destination node to write, as a pair, the pointer key and the data (value) to be written. The external-node access unit 160 transmits this request to the data destination node via the network I/O unit 120. The data destination node stores the specified set of (key, value, flag) in the disk device connected thereto. The flag is “false”. For example, in the case where the data destination node is the storage node 100a, a set (“pointer01”, “value01”, “false”) is written to the data store 210a. The external-node access unit 160 receives a write result from the data destination node. The node determination unit 150 records the write-requested pointer key and the label of the data destination node in association with each other in the pointer management table 112 stored in the storage unit 110.

At step S21, the node determination unit 150 instructs the disk I/O unit 130 to write the pointer key to the disk device 200. The key is a key specified by the write request. The data (value) is the pointer key determined at step S19. The flag is “true”. The disk I/O unit 130 writes a set of (key, pointer key, flag) to the disk device 200, and notifies the node determination unit 150 of the result. For example, a set (“key01”, “pointer01”, “true”) is written to the data store 210. The node determination unit 150 returns the write result to the client 300 via the network I/O unit 120.

As described above, the storage node 100 is capable of placing actual data in another node. In this case, the storage node 100 stores a pointer key linking to the other node in the disk device 200, instead of the actual data. Then, the storage node 100 instructs the other node to store the actual data associated with the pointer key. At the time of data update, the link is tracked based on a pointer key, and the actual data is updated.

In this connection, in the above step S15, the criteria (1) and (2) for determining whether to re-determine a data destination node are exemplified. Alternatively, other criteria may be applied. For example, determination of a data destination node may be performed when an index (for example, CPU utilization or the number of accesses) indicating a load on an own node is greater than a predetermined value continuously.

The following describes the process of step S16.

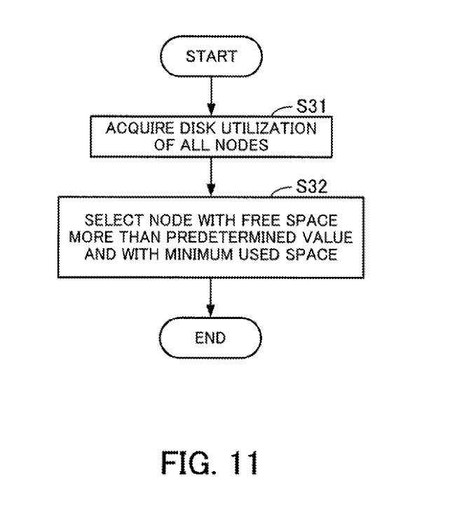

FIG. 11 is a flowchart illustrating a process for determining a data destination node according to the second embodiment. This process will be described step by step.

At step S31, the node determination unit 150 acquires the utilization of the disk devices 200, 200a, and 200b connected to the respective storage nodes 100, 100a, and 100b. The utilization includes the amount of used space and the amount of free space with respect to the disk device connected to a node. For example, the node determination unit 150 periodically acquires the utilization from the storage nodes 100, 100a, and 100b, and stores the utilization in the storage unit 110, so as to acquire the utilization from the storage unit 110. Alternatively, for example, the node determination 150 may be designed to acquire the current utilization from the storage nodes 100, 100a, and 100b at step S31.

At step S32, the node determination unit 150 selects a node with free space more than a predetermined value and with the minimum used space, as a data destination node.

As described above, the storage node 100 determines, as a data destination node, a node which has a comparatively large free space out of the storage nodes 100, 100a, and 100b. In this connection, a data destination node may be selected under other criteria. The criteria may be set according to an operation policy. For example, a data destination node may be selected according to any one or a plurality of the following criteria (A1) to (A3) and (B1) to (B3) for the following purposes (A) and (B).

(A) For the purpose of distributing the amount of data among the disk devices 200, 200a, and 200b: (A1) a node with free space more than a predetermined value and with the minimum used space is selected; (A2) a node with the maximum free space is selected; and (A3) a node which has a disk device with the minimum utilization relative to full space is selected.

(B) For the purpose of distributing load: (B1) a node which has a disk device with the minimum busy rate is selected; (B2) a node with the minimum number of inputs and outputs is selected; and (B3) a node with the minimum network utilization is selected.

Which method is employed for the selection is previously set in each storage node by an administrator of the distributed storage system, for example.

A plurality of criteria may be selected and used. In the case of combining the criteria (A1) and (A2), a plurality of nodes is allowed to be selected by relaxing the criteria of (A1), which selects a node “with the minimum used space”. (For example, three nodes with less used space are selected.) Then, one node with “the maximum free space” is selected from the plurality of selected nodes under the criteria of (A2).

In addition, in the case of combining the criteria (A3) and (B1), a plurality of nodes is allowed to be selected by relaxing the criteria of (A3), which selects a node which has “a disk device with the minimum utilization”. (For example, five nodes with less utilization are selected). Then, a node with “the minimum busy rate” is selected from the plurality of selected nodes under the criteria (B1).

The node determination unit 150 acquires utilization including data (such as free space and busy rate of disk device) used in these criteria, from the storage nodes 100, 100a, and 100b, so as to make a determination under applied criteria.

The following describes a process of step S19 of FIG. 10.

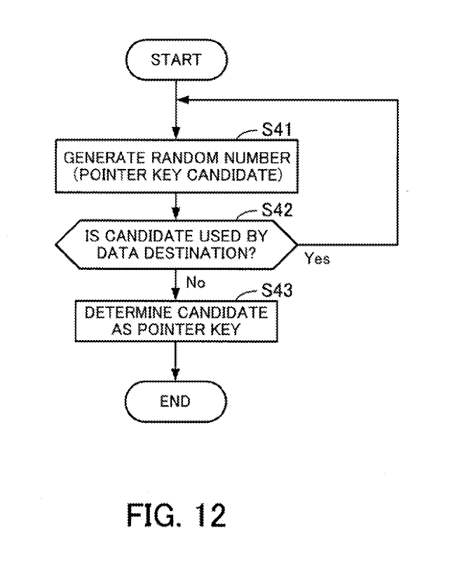

FIG. 12 is a flowchart illustrating a process for determining a pointer key according to the second embodiment. This process will be described step by step.

At step S41, the node determination unit 150 generates a random number with a predetermined pseudo random number generation algorithm. The generated random number is treated as a pointer key candidate.

At step S42, the node determination unit 150 determines whether the pointer key candidate has been used by a data destination node as a pointer key. If the pointer key candidate has been used, the process goes on to step S41. Otherwise, the process goes on to step S43. For example, the node determination unit 150 sends the data destination node an inquiry on whether there is data associated with a pointer key that is identical to the pointer key candidate in a data store, thereby making the determination. If such data is found, the pointer key candidate is determined to have been used. Otherwise, the pointer key candidate is determined to have been unused.

At step S43, the node determination unit 150 determines the random number generated at step S41 as a pointer key.

As described above, the storage node 100 determines a pointer key so that pointer keys do not overlap with each other in one data destination node.

In this connection, it is preferable that pointer keys also do not match hash values calculated from usual keys. For example, it is preferable that a random number which has a different number of digits from the strings of hash values is generated and then a pointer key is determined.

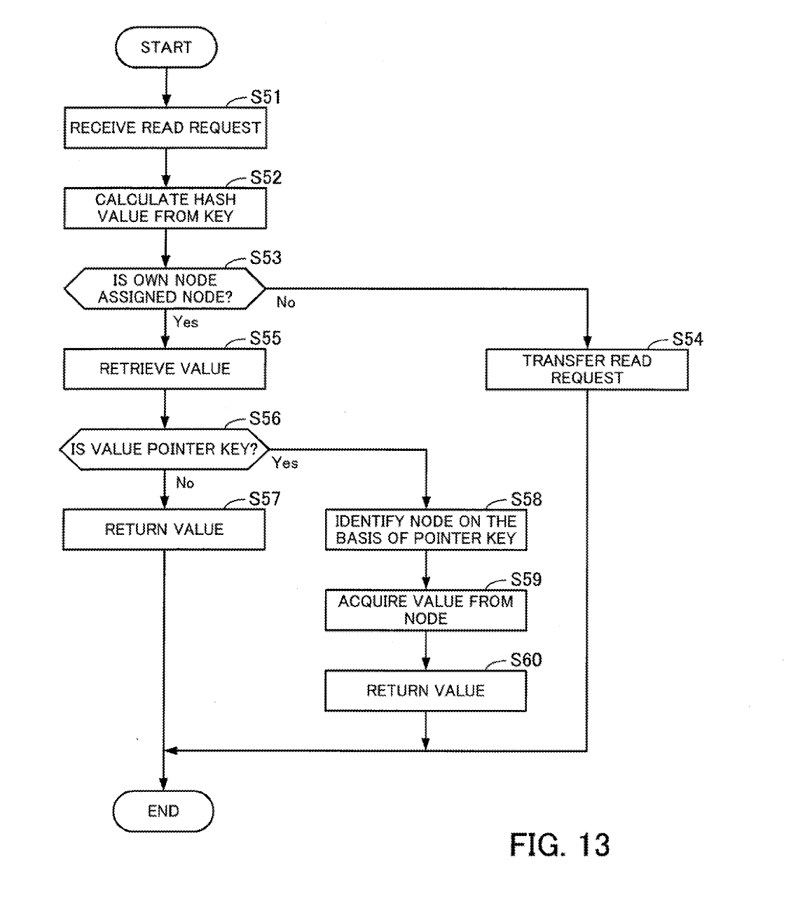

FIG. 13 is a flowchart illustrating a read process according to the second embodiment. This process will be described step by step.

At step S51, the network I/O unit 120 receives a read request from the client 300. The network I/O unit 120 outputs the read request to the node determination unit 150 via the access reception unit 140. For example, the read request includes a key “key01”.

At step S52, the node determination unit 150 calculates a hash value from the key included in the read request.

At step S53, the node determination unit 150 determines with reference to the assignment management table 111 stored in the storage unit 110 whether its own node is an assigned node responsible for the calculated hash value or not. If the own node is not the assigned node responsible for the hash value, the process goes on to step S54. Otherwise the process goes on to step S55.

At step S54, the node determination unit 150 transfers the read request to the assigned node via the network I/O unit 120. The assigned node, having received the read request, reads the data from the disk device connected thereto, and returns the read data to the client 300. Then, this process is completed.

At step S55, the node determination unit 150 retrieves data (value) associated with the key included in the read request from the data store 210 of the disk device 200. For example, data “pointer01” is retrieved for the key “key01”.

At step S56, the node determination unit 150 determines whether the data (value) is a pointer key or not. If the data is not a pointer key, the process goes on to step S57. Otherwise, the process goes on to step S58.

In this connection, a flag associated with the key indicates whether the data is a pointer key or not. The flag of “true” indicates that the data is a pointer key, and the flag of “false” indicates that the data is not a pointer key.

At step S57, the node determination unit 150 returns the data retrieved at step S55 to the client 300. Then, the process is completed.

At step S58, the node determination unit 150 identifies a data destination node with reference to the pointer management table 112 stored in the storage unit 110 and on the basis of the pointer key obtained as data (value) at step S55. For example, the pointer key “pointer01” indicates that a data destination node is the storage node 100a (label “B”).

At step S59, the node determination unit 150 instructs the external-node access unit 160 to acquire data (value) from the data destination node by specifying the pointer key as a key. The external-node access unit 160 generates a read request according to the instruction, transmits the request to the data destination node via the network I/O unit 120, and receives data associated with the pointer key from the data destination node. For example, the external-node access unit 160 receives data “value01” associated with the pointer key “pointer01” from the storage node 100a.

At step S60, the external-node access unit 160 returns the data received from the data destination node to the client 300 via the network I/O unit 120.

As described above, when obtaining a pointer key from the data store 210 for the key included in a read request, the storage node 100 identifies a data destination node on the basis of the pointer key. Then, the storage node 100 acquires data associated with the pointer key from the data destination node, and returns the data to the client 300.

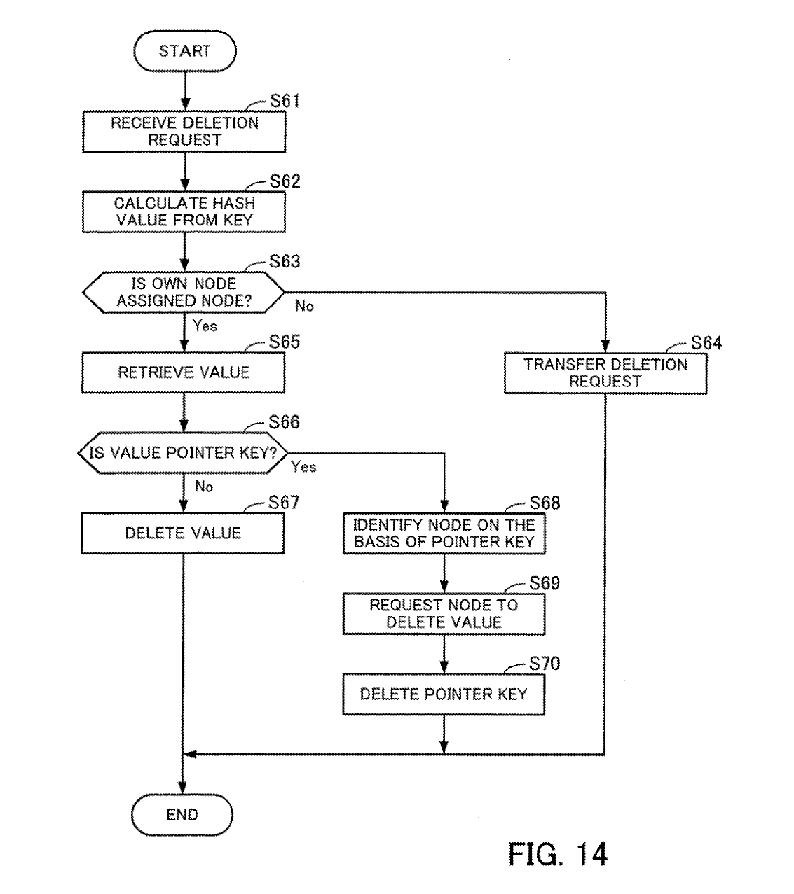

FIG. 14 is a flowchart illustrating a deletion process according to the second embodiment. This process will be described step by step.

At step S61, the network I/O unit 120 receives a deletion request from the client 300. The network I/O unit 120 outputs the deletion request to the node determination unit 150 via the access reception unit 140. For example, the deletion request includes a key “key01”.

At step S62, the node determination unit 150 calculates a hash value from the key included in the deletion request.

At step S63, the node determination unit 150 determines with reference to the assignment management table 111 stored in the storage unit 110 whether its own node is an assigned node responsible for the calculated hash value or not. If the own node is not the assigned node, the process goes on to step S64. Otherwise, the process goes on to step S65.

At step S64, the node determination unit 150 transfers the deletion request to the assigned node via the network I/O unit 120. The assigned node, having received the deletion request, deletes the specified pair of key and data from the disk device connected thereto, and returns a deletion result to the client 300. Then, the process is completed.

At step S65, the node determination unit 150 retrieves data (value) associated with the key included in the deletion request from the data store 210 of the disk device 200. For example, data “pointer01” is retrieved for the key “key01”.

At step S66, the node determination unit 150 determines whether the data (value) is a pointer key or not. If the data is not a pointer key, the process goes on to step S67. Otherwise, the process goes on to step S68. Whether data is a pointer key or not is determined in the same way as step S56 of FIG. 13.

At step S67, the node determination unit 150 instructs the disk I/O unit 130 to delete the data retrieved at step S65. The disk I/O unit 130 deletes the set of (key, value, flag) from the data store 210. The node determination unit 150 returns a deletion result received from the disk I/O unit 130 to the client 300. Then, the process is completed.

At step S68, the node determination unit 150 identifies a data destination node with reference to the pointer management table 112 stored in the storage unit 110 and on the basis of the pointer key obtained as the data (value) at step S65. For example, the pointer key “pointer01” indicates that a data destination node is the storage node 100a (label “B”).

At step S69, the node determination unit 150 instructs the external-node access unit 160 to request the data destination node to delete the data (value) by specifying the pointer key as a key. The external-node access unit 160 generates a deletion request according to the instruction, and transmits the deletion request to the data destination node via the network I/O unit 120, so that the data destination node deletes the data associated with the pointer key. For example, the external-node access unit 160 transmits a deletion request specifying the key “pointer01” to the storage node 100a. Then, the storage node 100a deletes a set of (key, value, flag), (“pointer01”, “value01”, “false”), from the data store 210a. The external-node access unit 160 receives a deletion result from the data destination node.

At step S70, the node determination unit 150 deletes a record with the pointer key obtained at step S65 from the pointer management table 112. The node determination unit 150 instructs the disk I/O unit 130 to delete the pointer key. The disk I/O unit 130 then deletes the set of (key, value, flag) from the data store 210. For example, a set (“key01”, “pointer01”, “true”) is deleted from the data store 210.

As described above, when obtaining a pointer key from the data store 210 for the key included in a deletion request, the storage node 100 identifies a data destination node on the basis of the pointer key. Then, the storage node 100 requests the data destination node to delete data associated with the pointer key, and also deletes the pointer key managed by the storage node 100.

As described above, even in the case of determining an assigned node on the basis of a hash value calculated from a key, the storage node 100, 100a, and 100b according to the second embodiment stores a pointer key associated with the key in the assigned node, instead of data. Then, the storage node 100, 100a, and 100b places the actual data associated with the pointer key in another node. This technique extends the limits of data placement.

For example, a pointer key is information that simply indicates a link, and therefore probably has a smaller data size than actual data. Therefore, in the case where an assigned node has a less free space, an imbalance in the amount of data is reduced by placing actual data in another node. In addition, for example, in the case where a high load is imposed on an assigned node, load is distributed by placing actual data in another node.

Further, for selecting another node (data destination node) for placing actual data, criteria suitable for operation are set. For example, different criteria may be set depending on purposes, such as the purpose of distributing the amount of data and the purpose of distributing load. This further facilitates distribution of the amount of data or load among the storage nodes 100, 100a, and 100b.

In this connection, this embodiment uses a flag for determining whether data (value) is a pointer key or not. Alternatively, another method may be employed. For example, defining that a pointer key includes a predetermined character string makes it possible to determine whether the data (value) is a pointer key or not based on whether the data (value) includes the character string or not.

### Third Embodiment

The third embodiment will now be described. Only different features from the above-described second embodiment will be described, and the same features will not be explained again.

In the second embodiment, the storage node 100, 100a, 100b determines an assigned node and data destination node. Alternatively, the clients 300 and 300a may be designed to make such determination. The third embodiment exemplifies the case where the client 300 and 300a makes the determination.

A distributed storage system according to the third embodiment has the same configuration as that of the second embodiment. In addition, storage nodes and clients according to the third embodiment have the same hardware components as the storage node 100 of the second embodiment, which was described with reference to FIG. 3. Although not specifically indicated, the same components of the third embodiment as those in the second embodiment are given the same reference number. However, the third embodiment has different software components of apparatuses from those of the second embodiment.

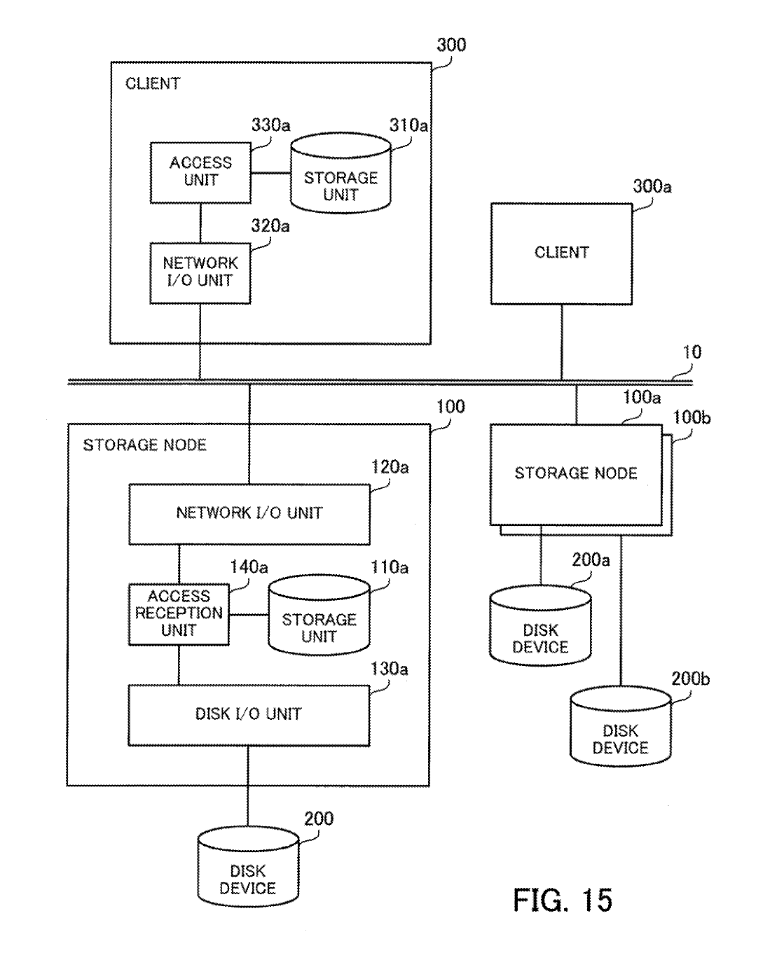

FIG. 15 is a block diagram illustrating example software components according to the third embodiment. Some or all of the components illustrated in FIG. 15 may be program modules to be executed by the storage nodes 100, 100a, 100b and the clients 300 and 300a, or may be implemented by using an FPGA, ASIC, or other electronic circuits. The storage nodes 100a and 100b are implemented by using the same components as the storage node 100. The client 300 is implemented by using the same components as the client 300.

The storage node 100 includes a storage unit 110a, network I/O unit 120a, disk I/O unit 130a, and access reception unit 140a.

The storage unit 110a stores an assignment management table 111.

The network I/O unit 120a outputs data received from the clients 300 and 300a to the access reception unit 140a. The network I/O unit 120a also transmits data received from the access reception unit 140a to the clients 300 and 300a. The network I/O unit 120a relays communications with the clients 300 and 300a.

The disk I/O unit 130a writes data received from the access reception unit 140a to the disk device 200. In addition, in response to an instruction from the access reception unit 140a, the disk I/O unit 130a reads and outputs data from the disk device 200 to the access reception unit 140a.

The access reception unit 140a receives a data access made from the client 300 and 300a, and performs data write, read, or deletion on the disk device 200 according to the access. In addition, the access reception unit 140a makes a notification of an assigned node with reference to the assignment management table 111 stored in the storage unit 110a in response to an inquiry on the assigned node from the client 300 and 300a.

The client 300 includes a storage unit 310a, network I/O unit 320a, and access unit 330a.

The storage unit 310a stores a pointer management table. The pointer management table exemplified in FIG. 7 according to the second embodiment may be applied here.

The network I/O unit 320a transmits an access request received from the access unit 330a to any one of the storage nodes 100, 100a, and 100b (for example, storage node 100). The network I/O unit 320a also receives and outputs a response from the storage node 100, 100a, and 100b in response to the access request, to the access unit 330a.

The access unit 330a generates an access request according to a data access made by a predetermined application, and outputs the access request to the network I/O unit 320a. Access requests include write requests, read requests, and deletion requests. The access unit 330a includes a key associated with data to be accessed, in the access request. For example, the key is specified by the application. The application, which causes the access unit 330a to make data accesses, is not illustrated in FIG. 15. The application may be implemented on the client 300 as a program to be executed by the client 300, or may be implemented on another information processing apparatus.

The access unit 330a makes an inquiry on an assigned node to any one of the storage nodes 100, 100a, and 100b, to determine an assigned node responsible for a hash value calculated from a key. At the time of data write, the access unit 330a determines a data destination node for storing actual data, depending on to the utilization of the assigned node. In the case of determining a node other than an assigned node as a data destination node, the access unit 330a generates a pointer key linking to the data destination node, and stores the pointer key associated with the specified key in the assigned node. Then, the access unit 330a stores the actual data associated with the pointer key in the data destination node. In the case of determining the assigned node as a data destination node, the access unit 330a stores the data associated with the specified key in the assigned node.

In addition, at the time of data read, if data read from an assigned node on the basis of a specified key is a pointer key, the access unit 330a identifies a data destination node with reference to the pointer management table stored in the storage unit 310a. The access unit 330a acquires data associated with the pointer key from the data destination node, and returns the data to the requesting application. In the case where the data from the assigned node is not a pointer key, the access unit 330a returns the data to the requesting application.

In addition, at the time of data deletion, if data stored in association with a specified key in an assigned node is a pointer key, the access unit 330a identifies a data destination node with reference to the pointer management table stored in the storage unit 310a. The access unit 330a then requests the data destination node to delete the data associated with the pointer key. If the data stored in association with the specified key in the assigned node is not a pointer key, on the other hand, the access unit 330a requests the assigned node to delete the data.

In this connection, the client 300 and access unit 330a of the third embodiment are examples of the information processing apparatus 1 and control unit 1b of the first embodiment, respectively.

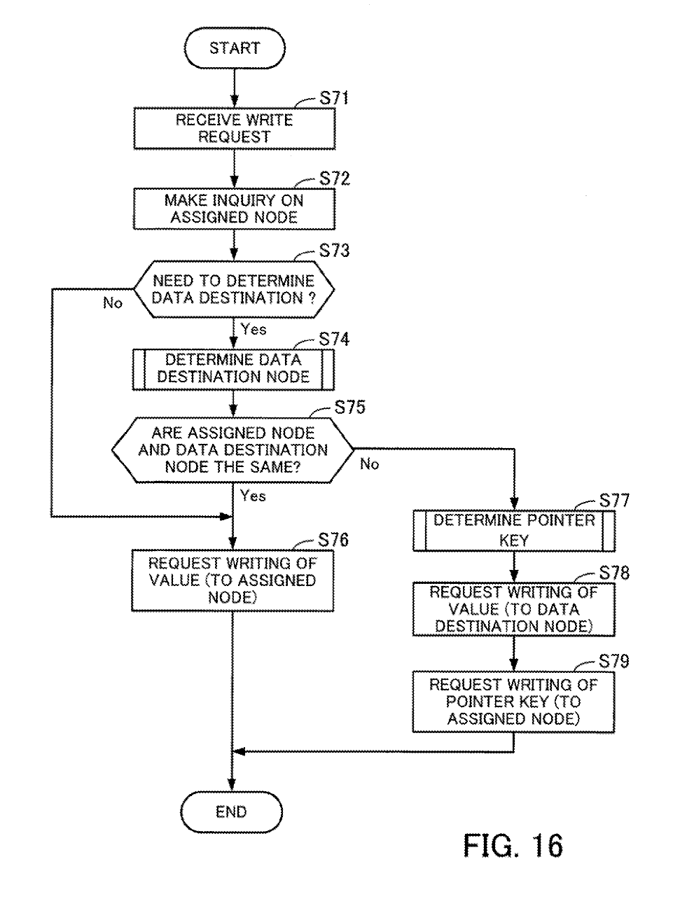

FIG. 16 is a flowchart illustrating a write process according to the third embodiment. This process will be described step by step.

At step S71, the access unit 330a receives a data write request from a predetermined application. The write request includes a key and data. For example, the write request includes a key “key01” and data “value01”.

At step S72, the access unit 330a calculates a hash value from the key included in the write request. The access unit 330a makes an inquiry on an assigned node responsible for the hash value to the storage node 100.

At step S73, the access unit 330a determines whether to determine a data destination node for placing actual data. If a data destination node needs to be determined, the process goes on to step S74. Otherwise, the process goes on to step S76. The access unit 330a determines whether to determine a data destination node, under any of the following criteria (1) and (2), for example. (1) The disk device 200 has a free space less than a predetermined value. (2) The size of data to be placed is larger than a predetermined value. Other criteria may be used. To make a determination under such criteria, the access unit 300a may be designed to periodically acquire the utilization (such as free space) of the storage nodes 100, 100a, and 100b, for example. Alternatively, the access unit 300a may be designed to acquire the utilization at step S73.

At step S74, the access unit 330a determines a data destination node under predetermined criteria. The process for determining a data destination node described with reference to FIG. 11 may be performed here. In this connection, the access unit 330a plays a role of performing this process, which is performed by the node determination unit 150.

At step S75, the access unit 330a determines whether the assigned node determined at step S72 is the same as the data destination node determined at step S74. If they are the same, the process goes on to step S76. Otherwise, the process goes on to step S77.

At step S76, the access unit 330a generates a write request for writing the data associated with the specified key, and transmits the write request to the assigned node. The assigned node writes a set of (key, value, flag) to the disk device connected thereto, in response to the write request. The key is a key specified by the application. The flag is “false”. For example, in the case where the assigned node is the storage node 100, a set (“key01”, “value01”, “false”) is written to the data store 210. When receiving a write completion notification from the assigned node, the access unit 330a notifies the requesting application of the write completion. Then, the process is completed.

At step S77, the access unit 330a determines a pointer key in the same way as the process for determining a pointer key described with reference to FIG. 12. In this connection, the access unit 330a plays a role of performing this process, which is performed by the node determination unit 150. For example, a pointer key “pointer01” is determined.

At step S78, the access unit 330a requests the data destination node to store, as a pair, the pointer key and the data (value) to be written. For example, the access unit 330a generates a write request that specifies a pointer key as a key and requests writing of data (value), and transmits the write request to the data destination node. The data destination node stores the specified set of (key, value, flag) in the disk device connected thereto. The flag is “false”. For example, in the case where the data destination node is the storage node 100a, a set (“pointer01”, “value01”, “false”) is written to the data store 210a. The access unit 330a receives a write result notification from the data destination node. The access unit 330a then records the write-requested pointer key and the label of the data destination node in association with each other in the pointer management table stored in the storage unit 310a.

At step S79, the access unit 330a requests the assigned node to write a pair of key and pointer key. For example, the access unit 330a generates a write request that specifies the key specified by the application and specifies the pointer key as data (value), and transmits the write request to the assigned node. The assigned node stores the specified set of (key, value, flag) in the disk device connected thereto. Here, the flag is “true”. For example, in the case where the assigned node is the storage node 100, a set (“key01”, “pointer01”, “value01”) is written to the data store 210. The access unit 330a receives a write result notification from the assigned node. Then, the access unit 330a notifies the requesting application of the write completion.

As described above, the client 300 is capable of placing actual data in a data destination node other than an assigned node. In this case, the client 300 causes the assigned node to store a pointer key linking to the other node, instead of the actual data. Then, the client 300 causes the data destination node to store the actual data associated with the pointer key.

With respect to step S73, the criteria (1) and (2) for determining whether to re-determine a data destination node were exemplified. Alternatively, this determination may be made under other criteria. For example, determination of a data destination node may be performed when an index (for example, CPU utilization or the number of accesses) indicating a load on an assigned node is greater than a predetermined value for a predetermined period of time continuously.

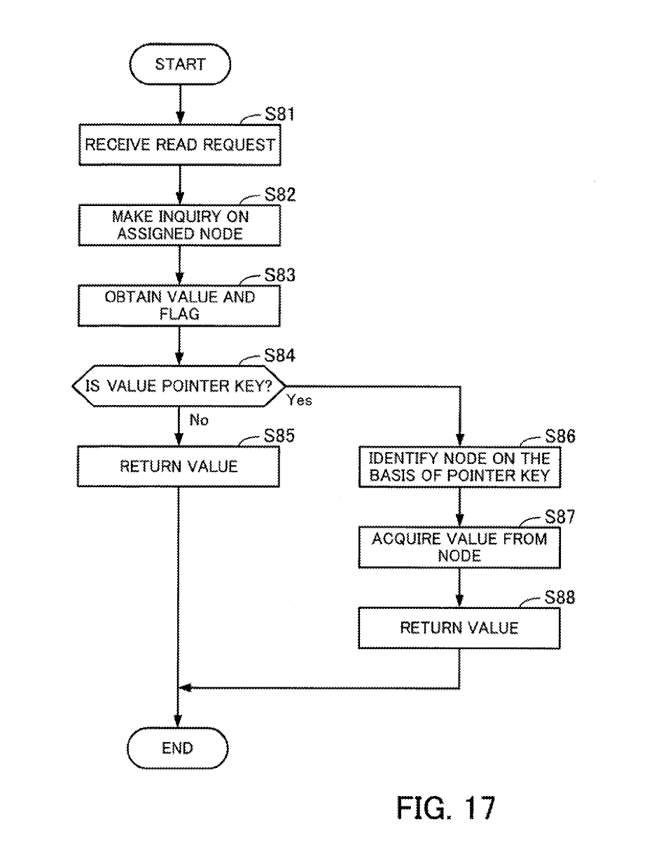

FIG. 17 is a flowchart illustrating a read process according to the third embodiment. This process will be described step by step.

At step S81, the access unit 330a receives a data read request from a predetermined application. The read request includes a key. For example, the read request includes a key “key01”.

At step S82, the access unit 330a calculates a hash value from the key included in the read request. The access unit 330a makes an inquiry on an assigned node responsible for the hash value to the storage node 100.

At step S83, the access unit 330a receives data (value) and flag associated with the key included in the read request from the assigned node. For example, in the case where the assigned node is the storage node 100, the access unit 330a receives the data “pointer01” and flag “true” associated with the key “key01”.

At step S84, the access unit 330a determines whether the data (value) is a pointer key or not. If the data is not a pointer key, the process goes on to step S85. Otherwise, the process goes on to step S86. Whether the data is a pointer key or not is determined based on the flag obtained at step S83. The flag of “true” indicates that the data is a pointer key, and the flag of “false” indicates that the data is not a pointer key. For example, since the flag obtained at step S83 is “true”, the data “pointer01” is a pointer key.

At step S85, the access unit 330a returns the data obtained at step S83 to the requesting application. Then, the process is completed.

At step S86, the access unit 330a identifies a data destination node on the basis of the pointer key obtained as data (value) at step S83, with reference to the pointer management table stored in the storage unit 310a. For example, the access unit 330a identifies the storage node 100a (label “B”) as a data destination node for the pointer key “pointer01”.

At step S87, the access unit 330a acquires the data (value) from the data destination node by specifying the pointer key as a key. For example, in the case where the data destination node is the storage node 100a, the access unit 330a obtains the data “value01” for the key “pointer01”.

At step S88, the access unit 330a returns the data obtained from the data destination node to the requesting application.

As described above, when obtaining a pointer key from an assigned node for the key included in a read request, the client 300 identifies a data destination node on the basis of the pointer key. Then, the client 300 acquires the data associated with the pointer key from the data destination node, and returns the data to the requesting application.

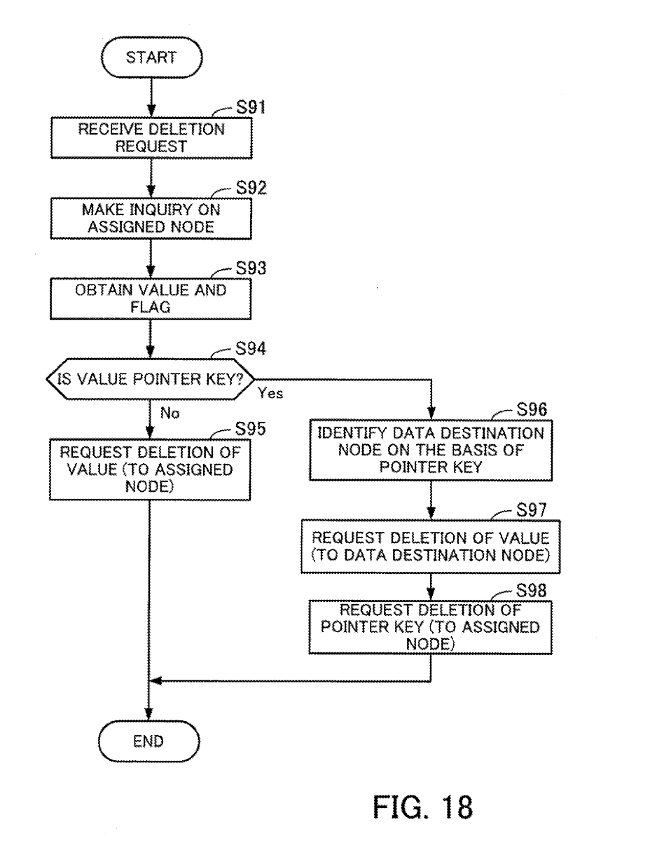

FIG. 18 is a flowchart illustrating a deletion process according to the third embodiment. This process will be described step by step.

At step S91, the access unit 330a receives a data deletion request from a predetermined application. The deletion request includes a key. For example, the deletion request includes a key “key01”.

At step S92, the access unit 330a calculates a hash value from the key included in the deletion request. The access unit 330a makes an inquiry on an assigned node responsible for the hash value to the storage node 100.

At step S93, the access unit 330a acquires data (value) and flag associated with the key included in the deletion request from the assigned node. For example, in the case where the assigned node is the storage node 100, the access unit 330a obtains the data “pointer01” and flag “true” associated with the key “key01”.

At step S94, the access unit 330a determines whether the data (value) is a pointer key or not. If the data is not a pointer key, the process goes on to step S95. Otherwise, the process goes on to step S96. Whether the data is a pointer key or not is determined based on the flag obtained at step S93. The flag of “true” indicates that the data is a pointer key, and the flag of “false” indicates the data is not a pointer key. For example, since the flag obtained at step S93 is “true”, the data “pointer01” is a pointer key.

At step S95, the access unit 330a generates a deletion request for deleting the data associated with the specified key, and transmits the deletion request to the assigned node. The assigned node deletes a set of (key, value, flag) from the disk device connected thereto, in response to the deletion request. The key is a key specified by the application. The access unit 330a receives a deletion completion notification from the assigned node, and notifies the requesting application of the deletion completion. Then, the process is completed.

At step S96, the access unit 330a identifies a data destination node on the basis of the pointer key obtained as data (value) at step S93, with reference to the pointer management table stored in the storage unit 310a. For example, the access unit 330a identifies the storage node 100a (label “B”) as a data destination node for the pointer key “pointer01”.

At step S97, the access unit 330a requests the data destination node to delete the data associated with the pointer key. For example, the access unit 330a generates a deletion request which specifies the pointer key as a key and requests deletion of the data (value), and transmits the deletion request to the data destination node. The data destination node deletes the specified set of (key, value, flag) from the disk device connected thereto. For example, in the case where the data destination node is the storage node 100a, the set (“pointer01”, “value01”, “false”) is deleted from the data store 210a. The access unit 330a receives a deletion result notification from the data destination node.

At step S98, the access unit 330a deletes a record with the pointer key obtained at step S93, from the pointer management table 112 stored in the storage unit 310a. The access unit 330a requests the assigned node to delete the pointer key. For example, the access unit 330a generates a deletion request that specifies the key specified by the application and requests deletion of the pointer key stored as data (value), and transmits the deletion request to the assigned node. The assigned node deletes the specified set of (key, value, flag) from the disk device connected thereto. For example, in the case where the assigned node is the storage node 100, the set (“key01”, “pointer01”, “true”) is deleted from the data store 210. When receiving a deletion completion notification from the assigned node, the access unit 330a notifies the requesting application of the deletion completion.

As described above, the client 300 and 300a according to the third embodiment stores a pointer key in association with a key in an assigned node, instead of data, even in the case where the assigned node is determined on the basis of the hash value calculated from the key. Then, the client 300 and 300a places the actual data associated with the pointer key in another node. This technique extends the limits of data placement.

For example, a pointer key is information that simply indicates a pointer, and therefore probably has a smaller data size than actual data. Therefore, in the case where an assigned node has a less free space, an imbalance in the amount of data is reduced by placing actual data in another node. In addition, for example, in the case where a high load is imposed on an assigned node, load is distributed by placing actual data in another node.

Further, for selecting another node (data destination node) for placing actual data, criteria suitable for operation are set. For example, different criteria may be set depending on purposes, such as the purpose of distributing the amount of data and the purpose of distributing load, as described in the second embodiment. This further facilitates distribution of the amount of data or load among the storage nodes 100, 100a, and 100b.

In this connection, this embodiment uses a flag for determining whether data (value) is a pointer key or not. Alternatively, another method may be employed. For example, defining that a pointer key includes a predetermined character string makes it possible to determine whether the data (value) is a pointer key or not based on whether the data (value) includes the character string or not.

Further, the second and third embodiments exemplify the case of storing data in one storage node. The same technique may be applied to the case of storing the same data in a plurality of storage nodes.

According to the embodiments, data placement in a plurality of nodes is flexibly performed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A storage control method to be executed in a system where a plurality of nodes is provided for storing data in association with a key and a node to be accessed is identified based on the key, the storage control method comprising:
storing, upon reception of a first key and first data, second data indicating a second key in association with the first key in a first node identified by the first key, and storing the first data in association with the second key in a second node;
detecting, upon reception of an access request that specifies the first key, data stored in association with the first key in the first node is the second data; and
accessing the first data stored in the second node on the basis of the second key indicated by the second data.

2. The storage control method according to claim 1, further comprising determining, upon reception of the first key and the first data, to store the first data in the second node, instead of in the first node, depending on one or both of a state of data storage and a state of processing of accesses in the first node.

3. The storage control method according to claim 1, further comprising selecting, upon reception of the first key and the first data, the second node from the plurality of nodes on a basis of one or both of states of data storage and states of processing of accesses in the plurality of nodes.

4. The storage control method according to claim 1, wherein the storing of the first data in the second node is performed by the first node or a client apparatus that makes a request for storing the first data.

5. The storage control method according to claim 1, wherein the detecting that the data associated with the first key is the second data and the accessing to the second node are performed by the first node or a client apparatus that makes the access request.

6. An information processing apparatus to be used in a system where a plurality of nodes is provided for storing data in association with a key and a node to be accessed is identified based on the key, the information processing apparatus comprising:
a memory configured to store information that indicates a correspondence between keys and nodes and at least indicates that a first node corresponds to a first key and a second node corresponds to a second key; and
one processor configured to perform a procedure including:
exercising, upon reception of the first key and first data, control to store second data indicating the second key in association with the first key in the first node and to store the first data in association with the second key in the second node; and
detecting, upon receipt of an access request that specifies the first key, that data stored in association with the first key is the second data, and accessing the first data stored in the second node on the basis of the second key indicated by the second data.

7. A computer-readable storage medium storing a computer program executed by a computer for controlling a system where a plurality of nodes is provided for storing data in association with a key and a node to be accessed is identified based on the key, the computer program causing the computer to perform a procedure comprising:
exercising, upon receipt of a first key and first data, control to store second data indicating a second key in association with the first key in a first node identified by the first key and to store the first data in association with the second key in a second node;
detecting, upon reception of an access request that specifies the first key, that data stored in association with the first key is the second data; and
accessing the first data stored in the second node on the basis of the second key indicated by the second data.
